(19) United States
(12) Patent Application Publication
(10) Pub. No.: US 2024/0380087 A1
(43) Pub. Date: Nov. 14, 2024

(54) BATTERY CELL WITH CATHODIC CAN

(71) Applicant: Our Next Energy, Inc., Novi, MI (US)

(72) Inventors: Sanket Sudam Mundhe, Troy, MI (US); Jin Sub Park, Seoul (KR); Seong Woo Park, Commerce Township, MI (US)

(21) Appl. No.: 18/661,543

(22) Filed: May 10, 2024

Related U.S. Application Data
(60) Provisional application No. 63/501,663, filed on May 11, 2023.

(51) Int. Cl. H01M 50/583; H01M 10/04; H01M 50/102; H01M 50/119; H01M 50/147; H01M 50/548; H01M 50/566

(52) U.S. Cl. CPC H01M 50/583; H01M 10/049; H01M 50/102; H01M 50/119; H01M 50/147; H01M 50/548; H01M 50/566; H01M 2220/20

(57) ABSTRACT

A cell that includes a can and an electrode assembly disposed in the can, the electrode assembly including at least one positive electrode and at least one negative electrode. The cell also includes a cap assembly at a positive terminal of the cell, the cap assembly includes a terminal block, a cap plate, an insulating member disposed between the terminal block and the cap plate, and a fuse disposed in a region of the insulating member. The insulating member is configured to insulate the cap plate from the terminal block, and the fuse is operable in two modes: a first cathodic mode in which the fuse electrically connects the terminal block to the cap plate and a second abuse mode in which the fuse disconnects, responsive to excessive current being generated, the terminal block from the cap plate.

### BACKGROUND

### Technical Field

The present disclosure generally relates to battery cells and more particularly to battery cells including a cathodic can and a safety fuse.

### Description of the Related Art

Appliances and vehicles such as battery-electric vehicles (BEVs) and plug-in hybrid-electric vehicles (PHEVs) may have an energy storage device, such as a high-voltage battery in a battery pack, which serves as the vehicle's source of propulsion. Components and systems that help manage performance and operations may be included in the battery. The battery pack may be required to be high in output power and may be subjected to the frequent repetitions of charge and discharge.

As battery packs are adapted to increase energy density for various high-powered applications safety and durability may also become an indispensable factor in the design of cells.

### BRIEF SUMMARY

According to an embodiment of the present disclosure, a cell is disclosed. The cell includes a can and an electrode assembly disposed in the can, the electrode assembly including at least one positive electrode and at least one negative electrode. The cell also includes a cap assembly at a positive terminal of the cell, the cap assembly includes a terminal block, a cap plate, an insulating member disposed between the terminal block and the cap plate, and a fuse disposed in a region of the insulating member. The insulating member is configured to insulate the cap plate from the terminal block, and the fuse is operable in two modes: a first cathodic mode in which the fuse electrically connects the terminal block to the cap plate and a second abuse mode in which the fuse disconnects, responsive to excessive current being generated, the terminal block from the cap plate.

In one embodiment, the can comprises aluminum material and a potential difference between a negative terminal of the cell and the can of the cell is maintained at greater than or equal to about 1.5V such as greater than or equal to 1.4V. The lager the difference, the better the corrosion resistance. The fuse may make the electrical contact between the positive (cathode) terminal and can which automatically maintains or keeps the potential of the can above that of the negative (anode) terminal.

In another aspect a battery pack comprising a plurality of the cells is designed. Responsive to the fuse of any one of the plurality of cells being activated in the second abuse mode, the corresponding cell may be removed and replaced with another cell.

According to an embodiment, a method of fabricating a cell is disclosed. The method includes providing a can of a cell and disposing an electrode assembly in the can, the electrode assembly includes at least one positive electrode and at least one negative electrode. In the method, a cap assembly is produced for a positive terminal of the cell, the cap assembly includes a terminal block and a cap plate. An insulating member is placed between the terminal block and the cap plate and a fuse is designed and placed in a section of the insulating member. The insulating member insulates the cap plate from the terminal block in an abuse operation mode of the cell. The fuse is designed to be operated in the normal mode (a first cathodic mode) to electrically connect the terminal block to the cap plate and the can and inhibit corrosion of the can, and in a second abuse mode to disconnect, responsive to a current exceeding a predetermined threshold, the terminal block from the cap plate.

### BRIEF DESCRIPTION OF THE DRAWINGS

To easily identify the discussion of any particular element or act, the most significant digit or digits in a reference number refer to the figure number in which that element is first introduced.

FIG. 1 depicts a diagram of a battery pack arrangement in accordance with an illustrative embodiment.

FIG. 2 depicts a cross-section of a first cell in accordance with an illustrative embodiment.

FIG. 3 depicts a cross-section of a second cell in accordance with an illustrative embodiment.

FIG. 4 depicts a cross-section of a third cell in accordance with an illustrative embodiment.

FIG. 5 depicts a schematic diagram of adjacent cells in accordance with an illustrative embodiment.

FIG. 6 depicts a cross-section of a fourth cell in accordance with an illustrative embodiment.

FIG. 7 depicts a cross-section of a fifth cell in accordance with an illustrative embodiment.

FIG. 8 depicts a cross-section of a sixth cell in accordance with an illustrative embodiment.

FIG. 9 depicts a routine 900 in accordance with one embodiment.

FIG. 10 depicts a functional block diagram of a computer hardware platform in accordance with one embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to an electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, battery cells are used in many applications including in electric vehicles and home energy storage units. The cells typically comprise an anode, a cathode, and an electrolyte. A separator may be used to prevent the anode and cathode from coming into contact if the electrolyte is not sufficient. The illustrative embodiments recognize that the anode may be the electrode at which oxidation reaction occurs (loss of electrons), and the cathode may be the electrode at which a reduction reaction occurs (gain of electrons)—In a battery, on the same electrode, both reactions may occur, depending on whether the battery is discharging or charging. The positive electrode is the electrode with a higher potential than the negative electrode. During discharge, the positive electrode may be the cathode, and the negative electrode may be the anode, and vice versa during charging. The illustrative embodiments recognize that most metals oxidize, thus by turning the metal into a cathode, one may prevent oxidation from happening at the metal since a cathode undergoes reduction rather than oxidation.

It is recognized that a cell may have a can or housing made of metal, for example, aluminum. By the housing making contact with the electrolyte of the cell, oxidation of the housing may take place over a period of time. The housing may thus, be protected from oxidizing or corroding by cathodic protection of the can. Cathodic protection may work by applying an electric current to the metal can, which may cause it to become positively charged relative to its surroundings. The illustrative embodiments recognize that this may create a condition where the metal is less likely to oxidize/corrode, as the electrochemical reaction that causes corrosion is suppressed.

The illustrative embodiments further recognize that knowing the lithium insertion potential of the can material may enable efficient design of the cell as corrosion may be directly related to the lithium insertion potential of the can material. Lithium insertion is used herein to generally to refer to the process of incorporating lithium ions into the crystal lattice of a host material.

The illustrative embodiments disclose a cell that comprises a can and an electrode assembly disposed in the can, the electrode assembly including at least one positive electrode and at least one negative electrode. The cell also comprises a cap assembly at a positive terminal of the cell, the cap assembly includes a terminal block, a cap plate, an insulating member disposed between the terminal block and the cap plate, and a fuse disposed in the insulating or a region of the member. The insulating member may be configured to insulate the cap plate from the terminal block, and the fuse may be operable in two modes: a first cathodic mode wherein the fuse electrically connects the terminal block to the cap plate and a second abuse mode wherein the fuse disconnects, responsive to current being generated beyond a predetermined threshold, the terminal block from the cap plate.

In an aspect, the can material is aluminum, the can material is in contact with the electrolyte, and the lithium insertion potential of aluminum is about 1.4V. Thus, the can voltage may be maintained above about 1.4V or above about 1.5V by cathodic protection based on the use of the fuse in the first cathodic mode. This may reduce or eliminate corrosion by making the can cathodic and inhibiting oxidation of the can and formation of an aluminum-lithium alloy.

In another aspect herein, since exposure of the can to excessive currents may pose a safety issue for the cell and a system in which the cell is contained, the fuse may be designed to function as an insulator in abuse conditions to increase a safety metric of the cell or of the system thus, inhibiting corrosion while tackling potential short circuits at the same time, even for adjacent cells that are in physical contact.

### Example System

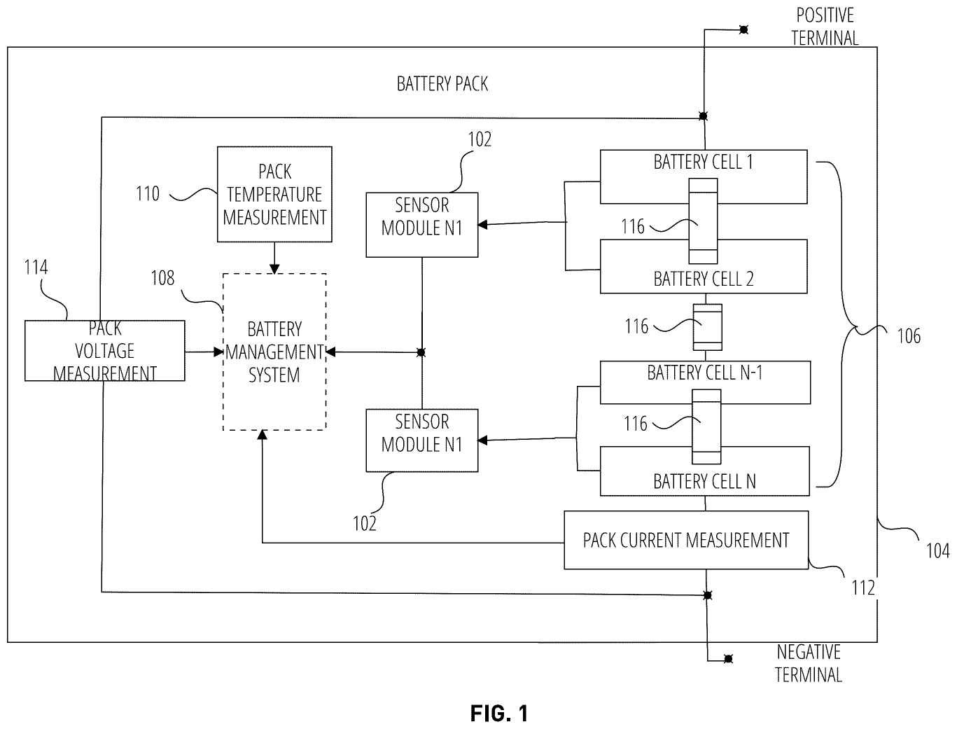

Turning now to FIG. 1, an example system in which the cPackell is employed is disclosed. The system may be a battery pack 104 comprising a plurality of cells 106 with cathodic cans and may be constructed from a variety of chemical formulations, including, for example, lead acid, nickel-metal hydride (NIMH) or Lithium-Ion. FIG. 1 shows a schematic of the battery pack 104 in a simple series configuration of N cells 106. Other battery pack configurations, however, may be composed of any number of individual battery cells connected in series or parallel or some combination thereof. The battery pack 104 may have a one or busbars 116 connecting the cells 106. The battery pack 104 may also have controllers such as the Battery management system (BMS 108) that monitors and controls the performance of the battery pack 104. The BMS 108 may monitor several battery pack level characteristics such as pack current 112, short circuits, pack voltage 114 and pack temperature 110. The BMS 108 may have non-volatile memory such that data may be retained when the BMS 108 is in an off condition. Retained data may be available upon the next key cycle.

In addition to monitoring the pack level characteristics, there may be cell 106 level characteristics that are measured and monitored. For example, the terminal voltage, current, and temperature of each cell 106 may be measured. A system may use a sensor module(s) 102 to measure the cell 106 characteristics. Depending on the capabilities, the sensor module(s) 102 may measure the characteristics of one or multiple of the cells 106. Each sensor module(s) 102 may transfer the measurements to the BMS 108 for further processing and coordination. The sensor module(s) 102 may transfer signals in analog or digital form to the BMS 108. In some embodiments, the sensor module(s) 102 functionality may be incorporated internally to the BMS 108. That is, the sensor module(s) 102 hardware may be integrated as part of the circuitry in the BMS 108 and the BMS 108 may handle the processing of raw signals.

It may be useful to calculate various characteristics of the battery pack. Quantities such a battery power capability and battery state of charge may be useful for controlling the operation of the battery pack as well as any electrical loads receiving power from the battery pack.

Battery pack state of charge (SOC) gives an indication of how much charge remains in the battery pack. The battery pack SOC may be output to inform the driver of how much charge remains in the battery pack, similar to a fuel gauge. The battery pack SOC may also be used to control the operation of an electric vehicle or other unit. Calculation of battery pack or cell SOC can be accomplished by a variety of methods. One possible method of calculating battery SOC is to perform an integration of the battery pack current over time. Battery model parameters may be identified through recursive estimation based on such measurements. The BMS 108 may estimate various battery parameters based on the sensor measurements. The BMS 108 may further ensure by way of the pack current 112 that a current of the cells 106 does not exceed a defined continuous current carrying capacity of the busbars 116.

### Example Architecture

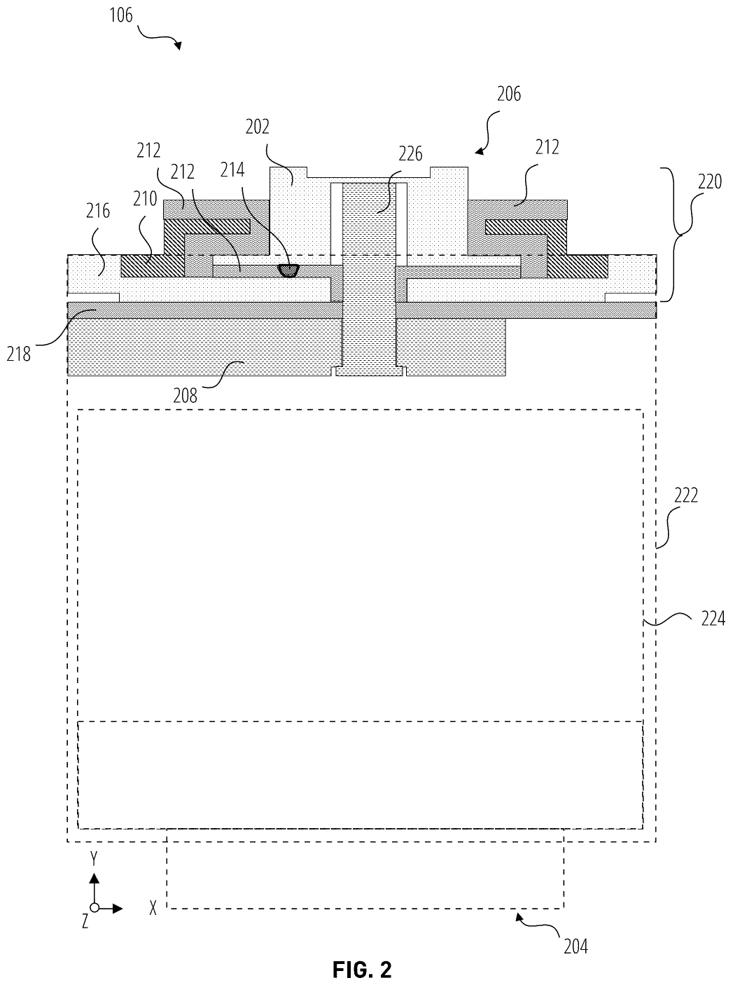

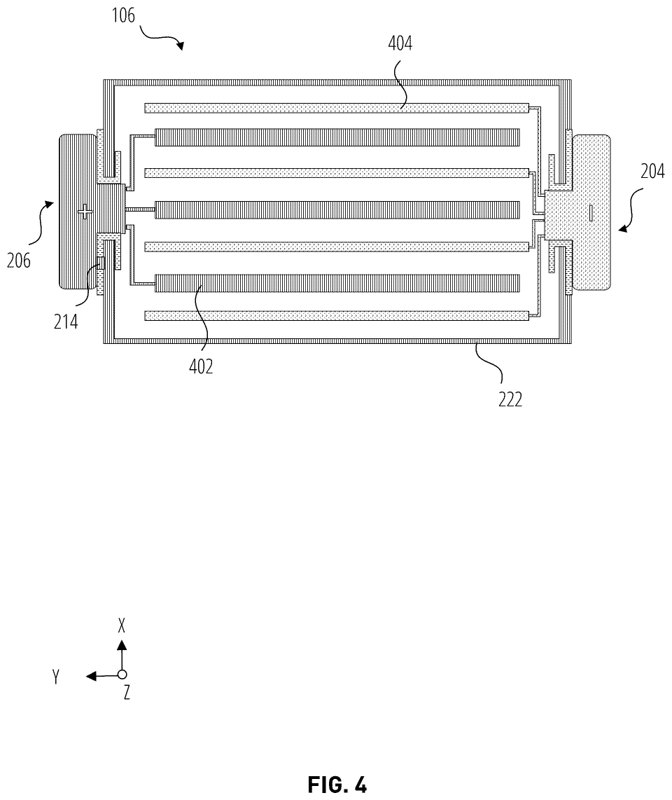

FIG. 2 illustrates a cross section of a cell 106 showing at least a cap assembly 220 and a can 222 of the cell. The cell 106 comprises the can 222 extending along a first axis (e.g., X-axis) to define a width, a second axis (e.g., Y-axis) orthogonal to the first axis to define a height, and a third axis (e.g., Z-axis) orthogonal to the first and second axes to define a thickness. The cell 106 further comprises an electrode assembly 224 disposed in the can 222, the electrode assembly 224 comprising at least one positive electrode (cathode 402, FIG. 4) and at least one negative electrode (anode 404, FIG. 4). The cap assembly 220 may be disposed at the positive terminal 206 area of the cell 106, the cap assembly comprising a terminal block 202, a cap plate 216 and an insulating member 212 disposed between the terminal block 202 and the cap plate 216. Another cap assembly (not shown) may be disposed at a negative terminal 204 area of the cell 106.

In the cap assembly 220, and disposed at the positive terminal area, a fuse 214 is positioned in the insulating member 212 or in a region of the insulating member (such as between two adjacent insulating members), and the insulating member insulates the cap plate 216 from the terminal block 202. However, the fuse 214 disposed in the insulating member 212 or a region thereof may be operable in the first cathodic mode to electrically connect the terminal block 202 to the cap plate 216 which may be welded and electrically connected to the can 222. As discussed herein, the fuse is also operable in a second abuse mode to disconnect the terminal block 202 from the cap plate 216 and thus from the can 222 responsive to detecting that a current passing through the fuse exceeds a predetermined threshold. In an example, the cross section of the fuse can be designed to allow a limiting current to pass and melt the fuse upon the current exceeding a predetermined value. Upon melting of the fuse, electrical connection between the terminal block and the can may be severed and the insulating member may insulate the terminal block from the can.

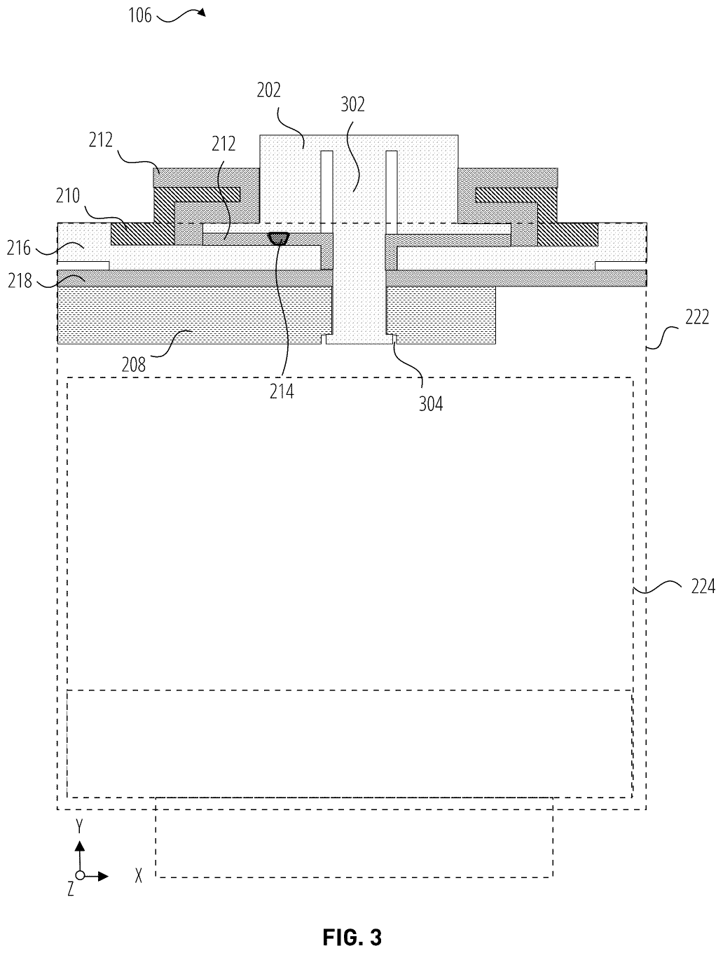

In an embodiment as shown in FIG. 2, the terminal block 202 may be electrically connected to a protrusion 226 of the current collector and the connection may be established via a welding process performed from outside the volume of the cell. In another embodiment as shown in FIG. 3, the current collector may comprise an opening 304 configured to receive and be electrically connected to an extension 302 of the terminal block 202.

Further, a bracket 210 may fix and confine the terminal block 202 onto the cap assembly 220 and may be physically separated from the terminal block 202 by a portion of the insulating member 212. The insulating member may be a 100% insulator and the cap plate insulator 218 may insulate the cap plate 216 from the current collector 208.

Turning now to FIG. 4, a cross section of the cell 106 is shown illustrating the electrodes of the electrode assembly 224 disposed in the cathodic can 222. The electrode assembly 224 may comprise a stack of cathodes 402 and anodes 404. According to one aspect, the can is aluminum and a positive polarity of the aluminum can is maintained by ensuring the negative terminal to CAN voltage is greater than 1.4 V, such as greater than 1.5V). The cathodic can further acts as a protective casing for the internal components of the battery, shielding them from damage due to external factors like impact or moisture and being highly resistant to corrosion, which helps to ensure the longevity and reliability of the battery.

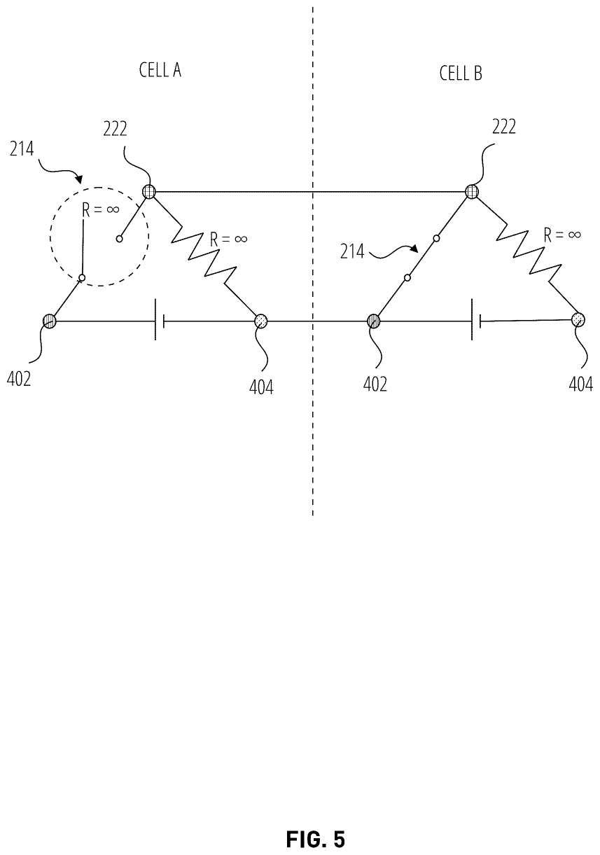

According to another aspect, a plurality of the cells 106 may be electrically connected in a system such as the system of FIG. 1. FIG. 5 shows an example wherein two adjacent cells (cell A and cell B) are electrically connected in a series configuration. In the first cathodic mode of operation of the fuse of cell A the potential of the terminal block of cell A is the same as the potential of the can of cell A, thus protecting the can from corrosion. However, when the can 222 of cell A comes into physical contact with the can 222 of cell B, an increased amount of current, that amounts to a current value above a predetermined threshold maximum current value, may flow through the fuse 214 of cell A causing the fuse of cell A to melt and thus disconnecting the cathode 402 of cell A from the can 222 of cell A and reducing the risk of a large short current. This may also happen to the fuse 214 of cell B in addition, or instead of the fuse 214 of cell A. If both the fuses are melted then both the cans may be neutral (not connected to any positive or negative potentials). If only one fuse is melted (e.g., say the fuse of cell A is melted), then the can of cell A may follow the potential of the can of cell B and may remain cathodic. In both the scenarios there may be chances of corrosion of the can of cell A because the potential of cell B may be dependent upon the position in the pack. Both cells may be removed as the outer insulation of those cells may be damaged.

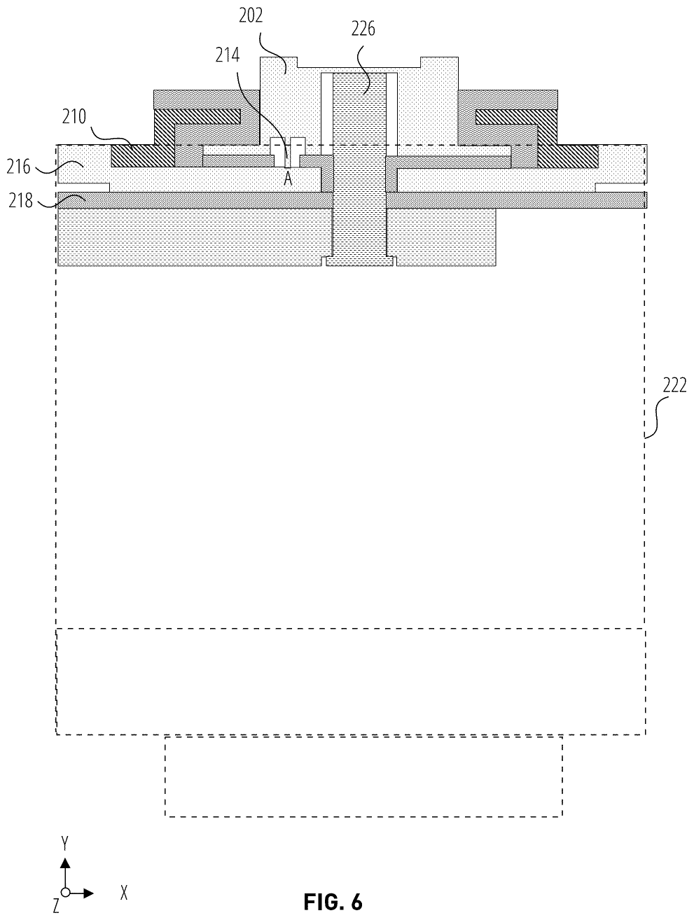

FIG. 6-FIG. 8 illustrate embodiments showing other configurations of the fuse and of the cell. The fuse 214 may be pillar shaped, for example, and may comprise a thin rectangular profile in the XY plane. The XY plane may be a plane in three-dimensional space that is perpendicular to the Z axis and more specifically perpendicular to the surface of the cell containing the cap plate, and parallel to the large wall surfaces of the cell. The fuse 214 may also have a circular profile in the XZ plane as shown in the figures. The fuse 214 may be a protrusion from (unibody with) the terminal and may be in physical contact with the cap plate 216 at position “A”. In some cases, the fuse 214 may extend into an opening in the cap plate 216 at position “A” and may make contact with the cap plate 216 without necessarily being unibody with the cap plate. The fuse 214 as disclosed herein may be configured to have a maximum current capability of between 2000 to 5000 Amps, or between 3000 to 5000 Amps, or between 3000 to 4000 Amps. By configuring the maximum current carrying capability, current exceeding the maximum current capability may melt the fuse to break electrical contact between the terminal block 202 and the cap plate 216. The diameter of the fuse 214 may be between 0.8 mm to 1.2 mm. A height of the fuse 214 in the Y axis direction may be larger 1.5 mm and tall enough to connect the terminal and cap plate (e.g., from 1.5 to 3 mm). These dimensions may be configured based on the fuse material used to achieve melting when the maximum current capability is exceeded.

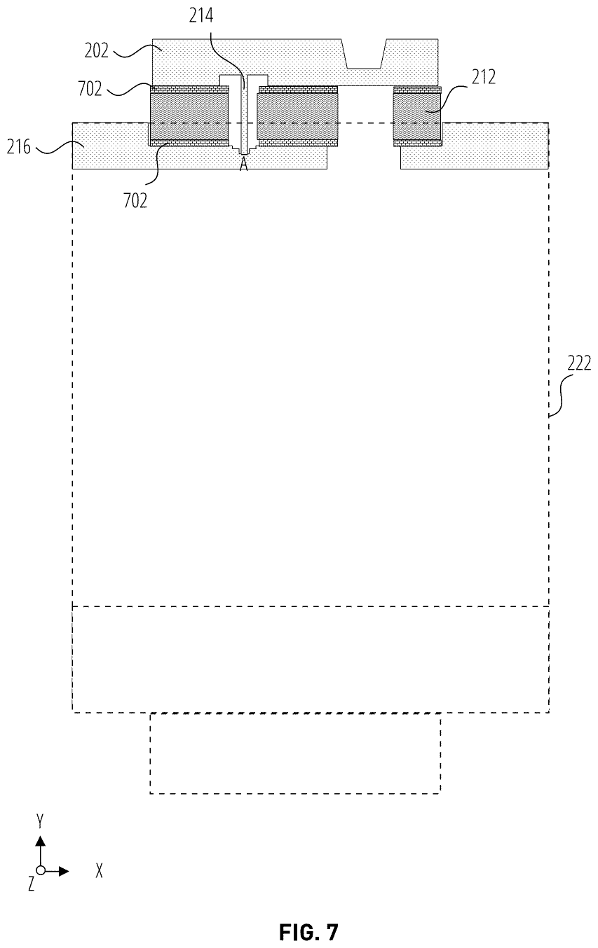

In an aspect herein as shown in FIG. 7, the insulating member may be disposed between the cap plate 216 and the terminal block 202 by brazing the insulating member 212 on both sides to for a braze 702. The braze 702 may be achieved by active or vacuum brazing and the insulating member may be a ceramic insulator.

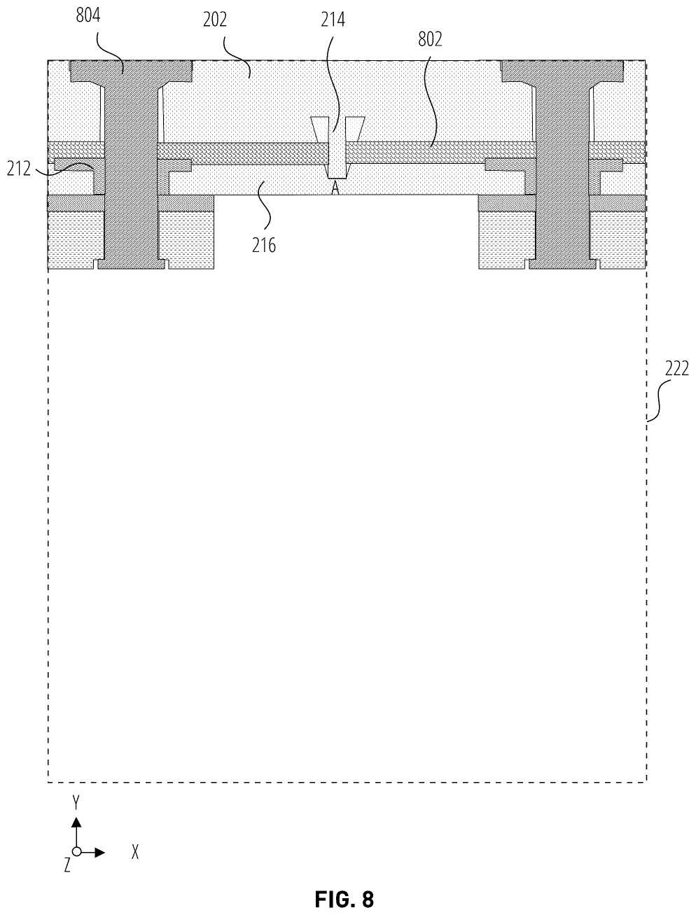

In another aspect as shown in FIG. 8, the fuse 214 may be part of a riveted terminal structure comprising the terminal block 202, the insulating member 212, the cap plate 216, a plastic insulator 802, and a rivet 804. The fuse 214 may be disposed in the terminal block 202, for example between two rivets 804. The fuse may make contact with the cap plate 216 at position A and upon the threshold current being exceeded, the fuse 214 may melt to disconnect the terminal block 202 from the cap plate. A plastic insulator disposed between the terminal block 202 and the cap plate 216 may prevent physical contact between the two. Of course, these are not meant to be limiting as other variations may be achieved in view of the descriptions herein.

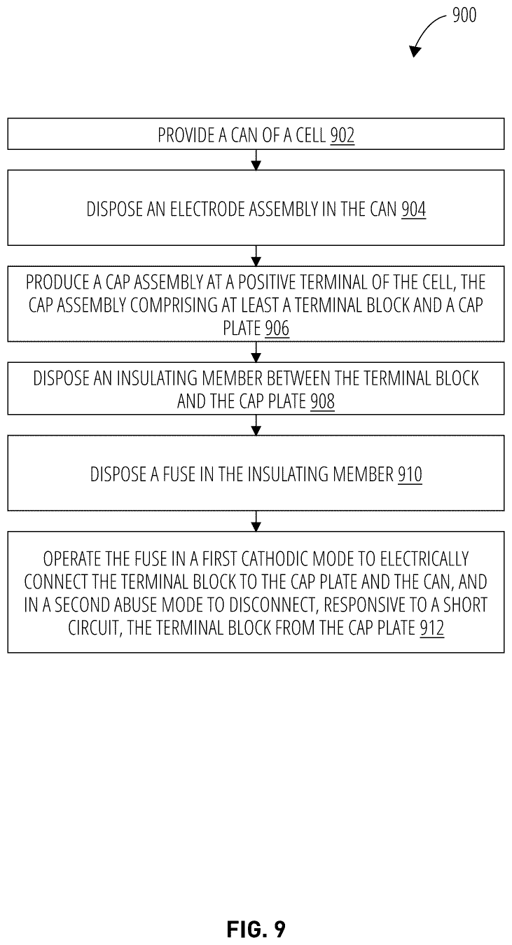

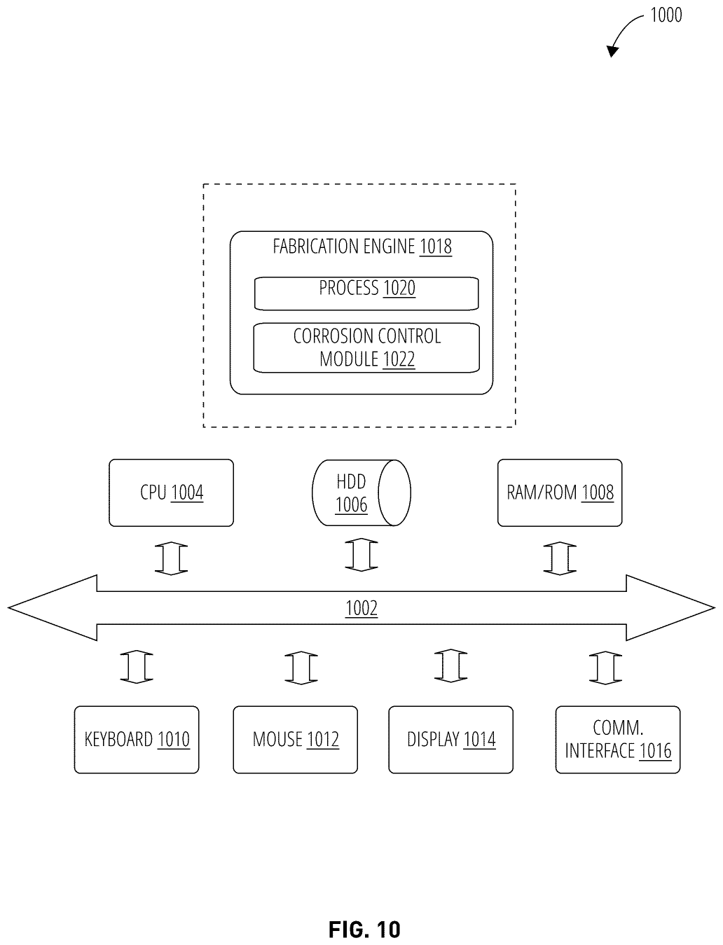

Turning to FIG. 9, a routine 900 for manufacturing a cell is described. The routine 900 may be performed by an engine such as fabrication engine 1018 of FIG. 10. The routine 900 may begin at block 902, wherein fabrication engine 1018 provides a can of a cell. In block 904, the fabrication engine 1018 may dispose an electrode assembly in the can, the electrode assembly comprising at least one positive electrode and at least one negative electrode. In block 906, the fabrication engine 1018 produces a cap assembly at a positive terminal of the cell, the cap assembly comprising at least a terminal block and a cap plate. In block 908, the fabrication engine 1018 disposes an insulating member between the terminal block and the cap plate and further disposes, in block 910 a fuse in the insulating member or a region thereof. The insulating member is configured to insulate the cap plate from the terminal block when the fuse has not melted. In block 912, the fabrication engine 1018 designs the fuse to be operated in a first cathodic mode to electrically connect the terminal block to the cap plate and the can, and further designs the fuse to be activated in a second abuse mode to disconnect, responsive to a current exceeding a predetermined threshold, the terminal block from the cap plate.

In one or more embodiments, the fabrication engine 1018 may design the fuse to be resettable after being activated in the second abuse mode. In both first cathodic mode and the second abuse mode, the can may be insulated from the anode.

In one or more other embodiments, the fabrication engine 1018 may manufacture a battery pack that comprises a plurality of the cells 106. The plurality of cells may be electrically connected together by one or more busbars in series and or parallel configurations. Other technical features may be readily apparent to one skilled in the art from the following figures, descriptions, and claims.

### Example Computer Platform

As discussed above, functions relating to methods and systems for fabricating a cell with a cathodic can and a safety fuse are disclosed herein. FIG. 10 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1000 may include a central processing unit (CPU) 1004, a hard disk drive (HDD) 1006, random access memory (RAM) and/or read only memory (ROM) 1008, a keyboard 1010, a mouse 1012, a display 1014, and a communication interface 1016, which are connected to a system bus 1002.

In one embodiment, the hard disk drive (HDD) 1006, has capabilities that include storing a program that can execute various processes, such as the fabrication engine 1018, in a manner described herein. The fabrication engine 1018 may have various modules configured to perform different functions. For example, there may be a process module 1020 configured to control the different manufacturing processes discussed herein and others. There may be a corrosion control module 1022 operable to provide an appropriate design and manufacturing of the fuse for corrosion prevention and protection against short circuits.

For the sake of brevity, conventional techniques related to making and using aspects of the invention may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A cell comprising:
a can extending along a first axis to define a width, a second axis orthogonal to the first axis to define a height, and a third axis orthogonal to the first and second axes to define a thickness;
an electrode assembly disposed in the can, the electrode assembly comprising at least one positive electrode and at least one negative electrode;
a cap assembly at a positive terminal of the cell, the cap assembly comprising:
a terminal block;
a cap plate;
an insulating member disposed between the terminal block and the cap plate; and
a fuse disposed in a region of the insulating member, the insulating member insulating the cap plate from the terminal block, and the fuse being operable in a first cathodic mode to electrically connect the terminal block to the cap plate and the can and being operable in a second abuse mode to disconnect, responsive to a current exceeding a predetermined threshold, the terminal block from the cap plate.

2. The cell of claim 1, wherein the terminal block is a cathode terminal.

3. The cell of claim 1, further comprising a bracket configured to confine the terminal block to a fixed position on the cap plate.

4. The cell of claim 1, wherein in the first cathodic mode the can is cathodic.

5. The cell of claim 1, wherein in the second abuse mode the fuse melts to create an infinite resistance between the can and the cathode and insulate the can from the cathode, wherein the can is neutral.

6. The cell of claim 1, wherein the fuse has a rectangular profile in the XY plane and a circular profile in the XZ plane.

7. The cell of claim 1, wherein the fuse is dimensioned to configure the predetermined threshold to be between 2000 Amps to 5000 Amps.

8. The cell of claim 1, wherein a dimeter of the fuse is 0.8-1.2 mm and a height of the fuse if 1.5 mm or larger.

9. The cell of claim 1, wherein the can comprises aluminum.

10. The cell of claim 9, wherein a potential difference between a negative terminal and the can is maintained at greater than or equal to 1.4V.

11. The cell of claim 9, wherein a potential difference between a negative terminal and the can is maintained at greater than or equal to 1.5V.

12. The cell of claim 1, wherein the cell has an external terminal-current collector welding structure, wherein the terminal block is welded to the current collector from an area external to a volume of the cell.

13. The cell of claim 1, wherein the cell has an internal terminal-current collector welding structure, wherein the terminal block is welded to the current collector from an area internal to a volume of the cell.

14. The cell of claim 1, wherein the fuse is resettable.

15. A battery pack comprising a plurality of cells designed according to the cell of claim 1, wherein responsive to any one of the plurality of cells being in the second abuse mode, the any one of the plurality of cells is replaced with another cell.

16. The battery pack of claim 15, wherein the plurality of cells are connected together by one or more busbars.

17. A method comprising:
providing a can of a cell;
disposing an electrode assembly in the can, the electrode assembly comprising at least one positive electrode and at least one negative electrode;
producing a cap assembly at a positive terminal of the cell, the cap assembly comprising a terminal block and a cap plate;
disposing an insulating member between the terminal block and the cap plate;
disposing a fuse in a region of the insulating member, the insulating member insulates the cap plate from the terminal block; and
operating the fuse in a first cathodic mode to electrically connect the terminal block to the cap plate and the can, and operating the fuse in a second abuse mode to disconnect, responsive to a current exceeding a predetermined threshold, the terminal block from the cap plate.

18. The method of claim 17, further comprising manufacturing a battery pack comprising a plurality of cells of the cell, wherein responsive to any one of the plurality of cells being in the second abuse mode, the any one of the plurality of cells is replaced with another cell.

19. The method of claim 17, further comprising maintaining a potential difference between a negative terminal and the can at greater than or equal to 1.4V.

20. The method of claim 17, further comprising maintaining a potential difference between a negative terminal and the can at greater than or equal to 1.5V.
